(19) United States
(12) Patent Application Publication
(10) Pub. No.: US 2014/0212548 A1
(43) Pub. Date: Jul. 31, 2014

(54) Beverage Bits

(71) Applicants: Locke White II, Blacksburg, VA (US); David M. Brown, Charlotte, NC (US)

(72) Inventors: Locke White II, Blacksburg, VA (US); David M. Brown, Charlotte, NC (US)

(21) Appl. No.: 14/238,539

(22) PCT Filed: Aug. 13, 2012
(86) PCT No.: PCT/US12/50594

§ 371 Date: Feb. 12, 2014

Related U.S. Application Data
(60) Provisional application No. 61/685,569, filed on Mar. 21, 2012.
(60) Provisional application No. 61/574,998, filed on Aug. 12, 2011.

(51) Int. Cl. A23L 1/212; A23L 2/52

(52) U.S. Cl. CPC A23L 1/2121; A23L 2/52
USPC 426/96; 426/102; 426/590

(57) ABSTRACT

The present invention relates to the field of beverage supplements. Provided by aspects of the invention are compositions for and methods of enhancing the flavor of a beverage by suspending fruit particles in the beverage just prior to consumption. Suspended fruit particles enhance the consumer's drinking experience by refreshing the flavor of the beverage with each sip. Fruit particles can be distributed in a beverage at different levels by altering the physical properties and composition of the fruit pieces. In one embodiment, the fruit pieces can be dehydrated to different levels. Alternatively, or in addition, embodiments of the present invention provide dehydrated fruit matter, which can be coated or processed with edible material to provide fruit particles of different weights such that the particles suspend at different levels when added to a beverage. As the consumer drinks the beverage, a relatively even distribution of beverage bits will be consumed.

### CROSS-REFERENCE TO RELATED APPLICATIONS

This application claims priority to and the benefit of the filing date of U.S. Provisional Application No. 61/574,998, filed Aug. 12, 2011, and U.S. Provisional Application No. 61/685,569, filed Mar. 21, 2012, the disclosures of which are hereby incorporated by reference herein in their entireties.

### BACKGROUND OF THE INVENTION

1. Field of the Invention

The present invention relates to the field of beverage supplements. Provided by aspects of the invention are compositions for and methods of enhancing the flavor of a beverage. More specifically, embodiments of the present invention provide dehydrated fruit matter, which can be coated or injected with edible material to provide fruit particles of different weights such that the particles suspend at different levels when added to a beverage. Suspended fruit particles in the beverage, added just prior to consumption, enhance the consumer's drinking experience by refreshing the flavor of the beverage with each sip.

2. Description of Related Art

Consumers have a huge assortment of choices when it comes to cold beverages. Having a large quantity to pick from, however, does not mean that the beverage selected will always satisfy the needs of the consumer. For example, with each swallow a consumer takes of their beverage, the flavor steadily diminishes. This is due to the sensory phenomenon called “neural adaptation,” a decline in the responsiveness of sensory receptors to a constant stimulus. Many foods and food products fall victim to this phenomenon, with beverages being more susceptible due to their usually homogeneous nature. More particularly, with each swallow of the beverage by the consumer, the flavor decreases for the consumer because their taste buds respond less and less until there is very little response at all. No matter what the consumer drinks, the consumer slowly becomes desensitized to the flavor.

Another problem is that even though juices and many sports drinks are considered to be healthy to drink, the majority of other beverages, including sodas, have almost no health benefits. Consumers today are very health conscious and are looking for ways to add nutrients to their diet, this includes what they drink. Many consumers refuse to even consider consuming a soft drink for this reason, which obviously affects sales of these products.

Another issue with beverages is that they are boring. Some beverages are packaged in specially shaped bottles, and others have the sports squirt spout, whiles others use eye catching coloring to provide an aesthetic benefit. There is really nothing available that gets the consumer involved in helping create the product and making it taste better. A great example of this concept in the food category is yogurt that has granola in a separate compartment in the lid that is poured in. This simple process not only gets the consumer to interact in an enjoyable way with the product, but it also makes the yogurt taste much better. Unfortunately, equivalent ways of enhancing beverages have not been possible until now.

### SUMMARY OF THE INVENTION

An object of embodiments of the present invention provides a composition for reducing neural adaptation from drinking comprising: a plurality of particles comprising fruit material, referred to as fruit bits, wherein two or more of the fruit bits have a buoyancy in a target beverage and weight is added to the fruit bit for counteracting the buoyancy and suspending the two coated fruit bits at different levels when dispersed in the target beverage.

Preferred are fruit bits that are coated, processed, or injected with additional edible material to provide additional weight to the fruit bit.

An object of the invention provides a plurality of particles comprising fruit material, each encased in an edible coating to provide a group of coated fruit bits; wherein two or more of the coated fruit bits have a buoyancy in a target beverage and the coating provides weight for counteracting the buoyancy and suspending the two coated fruit bits at different levels when dispersed in the target beverage.

Such compositions can comprise coated fruit bits, wherein the edible coating is a water-insoluble coating, such as wax or a coating comprising wax.

Preferred embodiments of the invention provide fruit bits further comprising added vitamins and minerals.

Objects of the invention provide fruit bits, wherein the fruit material comprises a moisture content ranging from about 0% to about 90% based on weight.

A further object of the invention provides a composition comprising coated fruit bits having one or more of a length, width, height, or diameter of about 1/128^{th}-¼^{th} inch.

In compositions and methods of the invention, the fruit material is processed by one or more of blending, pureeing, heating, or dehydrating.

In preferred embodiments, the coated fruit bits are packaged by segregating the coated fruit bits by one or more of weight, density, volume, or particle size.

Packaging of the fruit bits can be provided by a cellophane wrapper or a beverage cap with a foil or plastic seal for retaining the coated fruit bits within the cap.

Preferably, the cellophane wrapper or cap has multiple compartments for segregating the coated fruit bits by one or more of weight, density, volume, or particle size.

Additionally provided are compositions wherein coated fruit bits comprise air encased in the coating to add buoyancy to the coated fruit bits when dispersed in a beverage.

Compositions according to the invention can comprise coated fruit bits formulated to suspend in a target beverage having a density ranging from 0.8 g/mL to 1.3 g/mL.

Likewise, compositions of the invention can be formulated to alternatively, or additionally suspend in a beverage having a viscosity ranging from about 10 cP to about 110 cP.

Methods of the invention can comprise use of any of the compositions detailed in this specification for reducing neural adaptation from drinking. Preferred methods comprise: suspending, whether before purchase, at the time of consumption, during consumption, or just prior to consumption, a plurality of particles comprising fruit material, each encased in an edible coating to provide a group of suspended coated fruit bits; wherein two or more of the suspended coated fruit bits have a buoyancy in a target beverage and the coating provides weight for counteracting the buoyancy and suspending the two coated fruit bits at different levels when dispersed in the target beverage; and wherein neural adaptation is reduced when the suspended coated fruit bits are consumed while drinking the beverage.

### BRIEF DESCRIPTION OF THE DRAWINGS

The accompanying drawings illustrate certain aspects of some embodiments of the present invention, and should not be used to limit or define the invention. Together with the written description, the drawings serve to explain certain principles of the invention.

FIG. 1 is a diagram illustrating an embodiment of the invention, namely, dehydrated fruit particles (beverage bits) provided to the consumer in a cellophane wrapper, then added to a beverage by the consumer for suspension therein.

FIG. 2 is a diagram illustrating another embodiment of the invention, namely, dehydrated fruit particles (beverage bits) provided to the consumer sealed in the underside of a cap for a beverage container, wherein the consumer removes the beverage bits from the cap and pours them into the beverage for suspension of the fruit prior to and during consumption.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

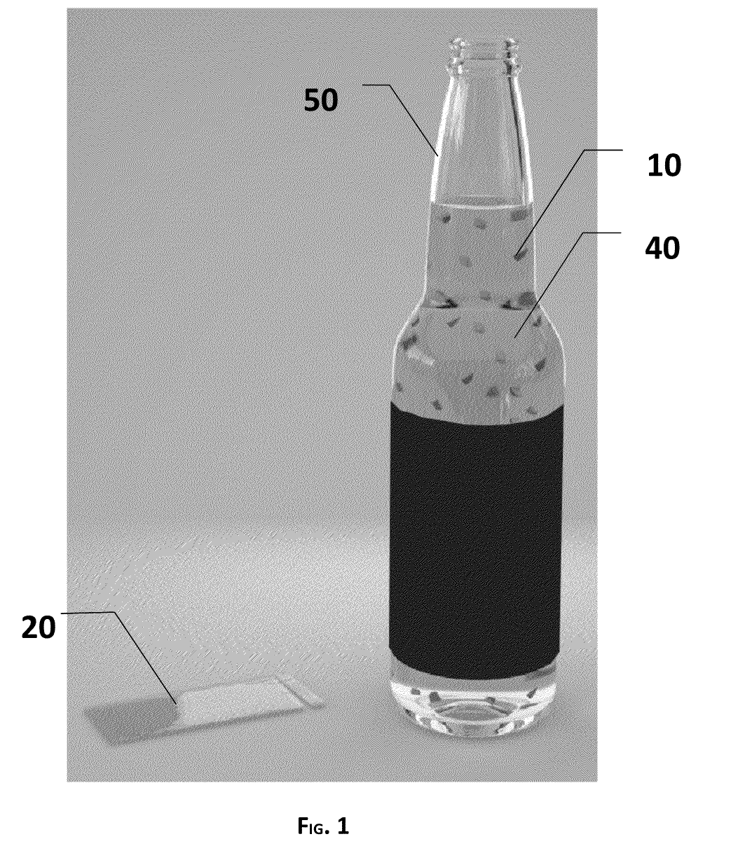

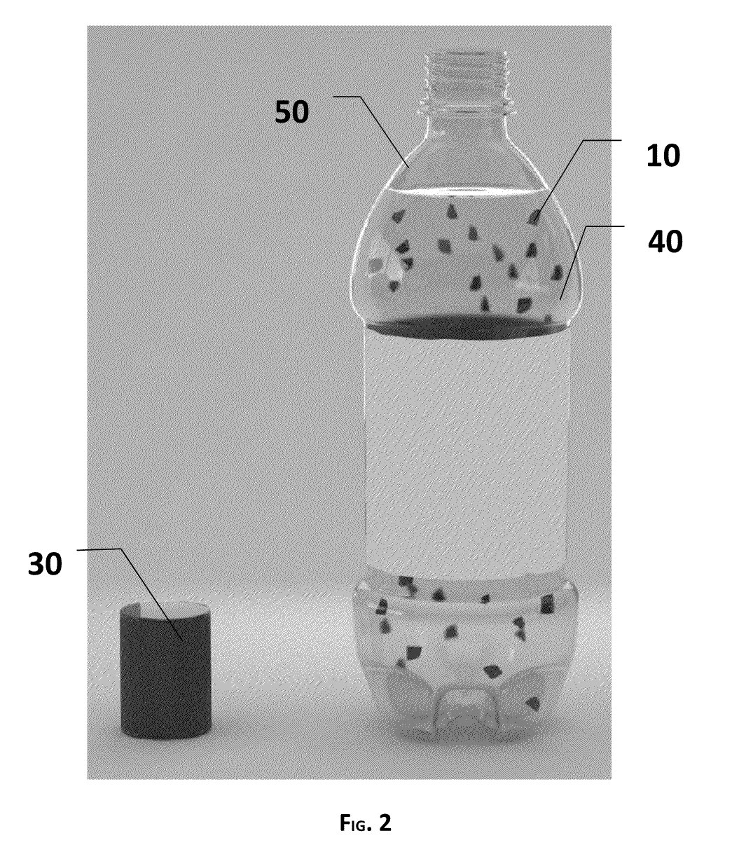

In embodiments of the invention, and as illustrated in FIGS. 1 and 2, the present invention relates to particles of fruit 10, beverage bits, which may be added to a beverage 40 to enhance the flavor of the beverage over the duration the beverage is consumed. In this specification, the terms fruit particles, beverage bits, fruit pieces, vegetable pieces or particles, or combinations thereof may be used interchangeably to refer to the substrate that is added to a beverage to enhance flavor. Preferably beverage bits are added to a beverage that is ready to drink, such as a beverage poured in a glass, or that is in a container, such as a bottle 50. Beverage bits can also be formulated for addition to consumer beverages during the manufacturing or packaging process to be provided directly in the beverage before purchase by the consumer. In such embodiments, the beverage bits can be provided with dry drink mixes or provided directly in the liquid beverages themselves. In such embodiments, the beverages in their pre-packaged containers can be displayed on the shelf and will provide an aesthetically pleasing look with the fruit particles distributed throughout the beverage similar to that of confetti. Beverage bits 10, when consumed, counteract neural adaptation of the drinker of the beverage and can make any beverage more exciting, healthier, and, most importantly, better tasting, as well as aesthetically pleasing.

Beverage bits 10 are small pieces of fruit, for example, 1/16 inch cubes, which have been processed to a number of different densities. The difference in density between the particles can be achieved by altering the water content of the overall particle. In embodiments, the beverage bit particles are grouped by similar size or a range of similar sizes. To group the beverage bits by size, the particles can be prepared and passed through a sequence of sieves having through holes decreasing in size. The grouping of particles can be done before or after water is removed from the particles. If performed prior to drying, in a group of the same size or approximately the same size particles, the beverage bits can be dried or dehydrated to remove water, resulting in a group of the same size beverage bits with differing water content. If performed after drying, portions of the mixture of beverage bits having different sizes can be dried to different degrees, then the dried particles can be separated by size.

Fruits that can be used in embodiments of the invention include for example any one or more of peaches, bananas, pomegranate, apricots, apples, pineapple, pears, plums, grapes, nectarines, cherries, strawberries, watermelons, blueberries, raspberries, blackberries, and all types of citrus fruits, such as oranges, limes, lemons, tangerines, tangelos, and grapefruit. Although fruits are used in preferred embodiments of the invention, vegetable can also be used and/or incorporated with fruits to prepare fruit and vegetable combinations. Suitable vegetables may include carrots, celery, spinach, sweet potato, kale, beets, tomato, lettuce, green beans, peas, broccoli, radishes, and so on.

If desired, nutrients can be added to supplement the level provided by the fruit and/or vegetables. Specifically, vitamins and minerals can be added (whether from natural foods or supplements) and can include, for example, vitamins A, B1, B2, B3, B5, B6, B7, B9, B12, C, D, E, K, Biotin, Choline and Folate, and combinations thereof. Minerals can include one or more of but are not limited to calcium, phosphorus, iron, iodine, zinc, copper, manganese, magnesium, chromium, selenium, molybdenum, potassium, sodium, boron, germanium, silicon, sulfur, and vanadium to name a few. Antioxidants may also be incorporated into the fruit bits and can include but are not limited to Vitamin A carotenoids, including alpha-carotene, beta-carotene, lycopene, lutein and zeaxanthin, coenzyme Q10, alpha-lipoic acid, iodide, and polyphenol antioxidants.

Beverage bits embodiments of the invention can comprise a natural fruit or vegetable content ranging from 0-100% based on the weight of the total composition (e.g., a bit, or particle). For example, preferred fruit or vegetable content can range from about 0-10%, or from about 5-20%, or from about 15-30%, or from about 25-40%, or from about 35-50%, or from about 45-60%, or from about 55-70%, or from about 65-80%, or from about 75-90% or from about 85-100%. The beverage bits can alternatively comprise artificial fruit or vegetables, or fruit or vegetable flavorings from any man made fruit or fruit flavoring. Additives may be incorporated into the fruit bits as well and can include any added substance that is not naturally occurring in fruit. The amount of additives can range for example from 0-80%, such as from about 5-25%, or from about 10-35%, or from about 15-45%, or from about 20-40%, or from about 30-50%, including from about 55-75%, or from about 60-65%, or from about 70-85% based on weight.

In embodiments, the beverage bits are small pieces of fruit and are preferably a maximum of about 1/16 inch in any dimension, including length, width, diameter, or height. The particle sizes may be processed to result in bits that are larger or smaller than 1/16 inch. Indeed, it is possible for bits to be invisible to the naked eye, such as about 1/64 inch or smaller. Preferably, beverage bits are small enough that when suspended in a beverage the particles are not detected by the consumer upon drinking the beverage. Representative particle size ranges for the beverage bits, include bits having one or more of a length, width, height, or diameter of about 1/128^{th} inch, 1/64^{th} inch, 1/32^{nd} inch, ⅛^{th} inch, ¼^{th} inch, ½ inch, 1 inch, or 2 inches. Any size, for example from 1/128^{th} inch to 3 inches, can be used depending on the application. Preferred particle size ranges can include from about 1/128^{th} inch to 1/32^{nd} inch, or from about 1/96^{th} inch to 1/48^{th} inch, or from about 1/16^{th} inch to ⅙^{th} inch and so on. Especially preferred are multiple beverage bits in a collection having a range of sizes, such as about half of the group having a particle size of about 1/80^{th} inch to about 1/16^{th} inch, or about one-forth of the group of beverage bits having a size that ranges from about 1/64^{th} inch to about 1/128^{th} inch, with the rest of the beverage bits having a size range that is not detectable to the eye.

In preferred embodiments, the beverage bits are cubes, however, the bits can take any geometric or abstract shape. Beverage bit shape will depend largely on the type of manufacturing process used to prepare the beverage bits and in most cases, unless controlled, the beverage bits will have random shapes. For example, the beverage bits can have an overall shape that is substantially spherical, pyramidal, cylindrical, conical, ellipsoidal, hyperboloidal, spheroidal, or paraboidal. The beverage bits can also be formulated to represent fictional or real characters, faces, buildings, animals, objects, vehicles, and so on. Tori, polyhedrons, tetrahedrons, octahedrons, dodecahedrons, icosahedrons, stellated dodecahedrons are also acceptable. The beverage bits can also have a thickness that is substantially less than the length, width, or diameter of the bit, such that the bits appear to be flat or planar. When appearing flat, the beverage bits can be characterized as having any of the specified three-dimensional shapes but on a two-dimensional basis, for example, a flat spherical shape may appear more like a disc or circle depending on the angle of view and a flat pyramidal shape may look more triangular from a certain perspective. Moreover, the particle shapes can be random and/or can have rounded edges, imperfect edges and sides.

The beverage bits can be processed and prepared according to any conventional method for processing fruit. The process for obtaining the dehydrated fruit pieces can include any one or more of the conventional methods for extracting, separating, blending, pureeing, dehydrating, and/or adding nutrients. Fruit and vegetable material can be from any source and can comprise whole fruit or vegetables, juice, fibrous portions, and/or skin, in any combination and amount. The fruit or vegetable material can be provided raw or can be cooked.

The beverage bits of preferred methods according to the invention are dehydrated. For dehydrating, the processes outlined in U.S. Pat. No. 6,623,779 can be used, for example, which describes a process in which the dehydrating step dries raw, ⅛ inch thick pieces of fruits and vegetables at 70 degrees Celsius for approximately 30-60 minutes to remove approximately 50% of the water contained in each piece. Dehydration of the fruit and/or vegetable substrate can be achieved by exposing the substrate to heat for an amount of time sufficient to remove an amount of water desired to achieve a particular result. Preferably, the substrate is dehydrated at a temperature ranging from about 20 degrees Celsius to about 120 degrees Celsius for a time ranging from approximately 10 minutes to 2 days. In specifically preferred embodiments, the substrate can be exposed to air at room temperature for about 1-2 days, or can be dried in an oven at a temperature of about 60 degrees Celsius for about 2 hours. Further, blanching can be performed, for example, at 80 degrees Celsius, if desired. Dehydrated fruit or vegetable matter or pieces according to embodiments of the invention may also be obtained by dehydrofreezing, dehydrocanning, osmotic dehydration, freeze drying, or other methods well known to the food industry. Indeed, any of the processing techniques described, for example, in U.S. Pat. Nos. 3,931,434 (methods of dehydration using the combination of pressure and dehydration), 4,104,414 (methods of dehydrating fruit juice), 5,000,972 (methods for obtaining softer fruit pieces by soaking fruit in a solution, then dehydrating under vacuum), 5,362,503 (dehydration to obtain dried fruits), 5,020,237 (using infrared and microwave energy to vacuum dehydrate fruit) can be used to prepare the beverage bits of embodiments of the present invention.

Beverage bits can be processed to any degree of dehydration. Preferably, the beverage bits when packaged and ready for consumption comprise a moisture content from about 0% to almost 100% water based on weight. For example, the water content of the beverage bits can range from about 1-5% water, or from about 2-10% water, or from about 3-15% water, or from about 4-20% water, or from about 6-30% water, or from about 7-35% water, or from about 8-40% water or from about 9-45% water, or from about 11-50% water, or from about 12-55% water, or from about 13-60% water, or from about 14-65% water, or from about 16-70% water, or from about 17-75% water, or from about 18-80% water, such as from about 19-25% water, such as from about 21-23% water, or from about 27-38% water.

A specific processing method of the invention can comprise any one or more of the typical processing techniques mentioned above. Specifically, one method of processing and preparing fruit bits can include providing a fruit concentrate that comprises in the range of about 25% to about 75% moisture based on weight, or from about 30-90 Brix. This concentrate can then be dehydrated to remove some of the moisture and obtain a concentrate having a moisture content of about 10-20%, and preferably is about 80 Brix. Any commercial fruit juice concentrate can be used. One method of removing the excess moisture from the concentrate is to heat the concentrate at a temperature of about 200-400 degrees Fahrenheit for about 10minutes to about 5 hours. Additionally, some of the excess moisture can alternatively or in addition be vacuumed off.

The juice concentrate with reduced moisture content can also be processed or mixed with fruit purees and one or more gelling agents, such as gelatin and/or pectin, which are added either before or after cooking the fruit material. The fruit material or fruit material mixture is then deposited on a Mogul™ machine to produce the final product, if specific shapes are desired for the fruit bits. Natural colors, flavors, or additives can be added, preferably on a continuous basis. The resulting fruit material can then be cured for up to 24 hours. Other similar methods of processing the fruit material are disclosed in U.S. Published Patent Application Publication No. 2010/0266744, entitled “All Natural Fruit Snack and Method of Manufacturing an All Natural Fruit Snack,” which can also be used to prepare the fruit material and/or fruit bits of the present invention.

Another representative method of preparing the fruit material for the fruit bits can include the method described in U.S. Pat. No. 6,528,102, entitled “Fruit Snacks with Varied Center Filling, which describes a general process for manufacturing snack pieces. According to this method, at least two liquid snack materials are prepared. These snack materials can comprise any of the following in any combination: fruit juices or purees, corn syrup, high fructose corn syrup, sugar, corn starch or other food starches, gelatin, pectin, sorbitol, acid, sodium citrate, natural and/or artificial colors, natural and/or artificial flavorings, buffers, vitamins, preservatives and nutrients. The liquid fruit snack materials are placed in a dispensing apparatus and dispensed into a tray or other receiving device, typically containing corn starch or other food starch materials. The fruit material is optionally stamped with a Mogul™ to create desired impressions, such as the shape of fruits, animals, children's characters, etc. The filled starch trays may then be set aside for approximately 24 to 48 hours so that the gelatin, pectin and other materials can solidify at least the jacket of the deposited fruit snack materials.

This center filling material or edible material added to or injected into the fruit bits of the present invention may comprise any one or more of the following: a fruit filling comprising fruit juices, sugar, corn syrup, gelatin, pectin, acid, artificial colors, natural and artificial flavors, vitamins, minerals, binders, etc. or a liquid filling which may contain sweetener, corn syrup, sorbitol, water, acid, natural and artificial flavoring, and other minor ingredients. In embodiments, the sugar and corn syrup may be added in solution form as a soft candy premelt and can be cooked to obtain a resultant 60%-85% solids content. For some applications, cooking the center filling material to about 77% solids has been found to be effective. Steam is a preferred heat source for heating the filling, which can achieve a temperature of approximately 455 degrees Fahrenheit. After cooking, if desired, the fruit materials may be processed further in a vacuum chamber to remove any air bubbles and continue evaporation of liquids at lower temperatures.

Beverage bits 10, in a preferred embodiment shown in FIG. 1, are packaged in a cellophane wrapper 20 that is a small flexible plastic container that is commonly used to hold food. The wrapper can also be wax paper, a foil packet, or other moisture proof container for holding the beverage bits prior to consumption. Paper can also be used, however, such embodiments may have a lower shelf life due to moisture permeating the paper packet.

In another embodiment shown in FIG. 2, beverage bits 10 are packaged in an underside compartment of cap 30, which can be a screw-off top commonly used with drink bottles. Cap 30 can be provided a bit taller than normal to provide the additional space needed to hold beverage bits 10. There is plastic film (not shown), or foil film, that covers the opening in the underside of cap 30 to keep the beverage bits 10 in place until needed by consumer. The plastic or foil seal is then easily punctured by the consumer and torn open with the tip of a finger to release the beverage bits 10 and add them to the beverage.

The beverage bits can be packaged in groups according to one or more factors, such as size, density, or moisture content, etc. For example, beverage bits with a certain range of moisture content can be packaged in a packet together, while beverage bits with a lower moisture content are grouped and packaged with one another, and while beverage bits with a higher moisture content are grouped/packaged together. By packaging the beverage bits according to their moisture level, all of the beverage bits in a single package will retain the same moisture level, whereas packaging beverage bits with differing moisture levels together may result in moisture transfer from the higher moisture content beverage bits to the lower moisture content beverage bits. Alternatively, a multi-compartment package can be provided for segregating the beverage bits by size, density, or moisture content.

In one embodiment, the beverage bits are created by dehydrating groups of various sized fruit pieces to a range of densities. Density is a function of mass and volume of a particle. As the fruit or vegetable substrate is dehydrated, the density of the particle is changed due to the loss of water, which results in a loss of mass, and a loss in volume because the water is removed. By dehydrating the fruit pieces to obtain a collection of beverage bits where one or more of the beverage bits have different densities, the pieces can be suspended in a beverage at different levels. In the context of the invention, the term suspend is meant to refer to a particle that is neither floating at the top of a liquid or that is lying on the bottom of the container in which the liquid is disposed.

In some embodiments, over time the beverage bits while immersed in a beverage may rehydrate thus having a change in density over time. Thus, although the beverage bits may initially be suspended at a particular level within a beverage, over time one or more of the beverage bits may sink to a lower level or even to the bottom or may rise to a higher level even ascending to float on the top of the beverage. Preferably, the beverage bits are formulated to suspend in a beverage for up to about 2 hours. Although the particles may slowly be sinking or floating within the beverage over time, movement of the particles within the system will in most embodiments not be detected by the naked eye. Likewise, in embodiments, the beverage bits can be formulated to suspend in a beverage indefinitely, for example, if the beverage bits are added to a beverage at the time of bottling instead of by the consumer at the time of drinking.

The sinking, floating, and suspension capabilities of the beverage bits are also determined by the density of the solution surrounding the beverage bits, i.e., the beverage in which the beverage bits are disposed. Most liquids have densities between 0.8 g/mL and 1.3 g/mL. For example, a non-diet soda typically has a higher density compared to water due to the higher sugar content (approximately a density difference of 0.03 g/mL) and will sink to the bottom of water, while a diet soda has a lower density than or roughly the same density of water and will float on top of water. Beverage bits of embodiments of the present invention can be formulated to be used with specific types of beverages. Further, for example, ice (solid water) floats on water because it is about 9% less dense than liquid water. In solid form, the ice takes up about 9% more space than water, so a liter of ice weighs less than a liter of water.

More particularly, the beverage bits can be used with any type of fluid. Preferably, potable fluids are used when formulating the beverage bits for beverages. The beverage bits substrates can be used in any beverage, including for example and without limitation fruit drinks with any amount of fruit or vegetable juice, cider, fruit and vegetable juices, soft drinks, water, purified water, distilled water, mineral water, carbonated water, soy drinks, tea, coffee, energy drinks, sports drinks such as Gatorade™, nutritional drinks such as Pediasure™ or Ensure™, beer, alcoholic cider, wine, liqueur, spirits, and milk to name a few. Beverage bits may also be added to powdered drink mixes, such as Kool-Aid™, Crystal Light™, or Tang™, whether at the time of preparing the drink or even during the manufacturing process. Beverage bits can be used in any individual or combination of beverages or drinks as defined above.

In addition to density, in which weight and volume are factors, other factors such as buoyancy, air content, and surface area may also have an effect on the suspension of the beverage bits in a beverage, and whether the particles will float or sink in a beverage.

Exemplary embodiments can comprise a group of beverage bits, whether coated, uncoated or comprising added weight, that are formulated with at least some of the particles having densities in the range of about 1.004-1.006 g/mL. Such a range of densities would be sufficient for suspending one or more of the particles in a lager with a density of about 1.005 g/mL. If the grouping of beverage bits comprises bits with higher densities, such as about 1.1 g/mL, those bits will sink to the bottom of the beverage. Whether the sinking occurs immediately or over time will depend on the amount of difference in density between the particle and the beverage. Similarly, if the collection of beverage bits comprises bits with lower densities than that of the lager, such as 0.9 g/mL, then those beverage bits will float to the surface of the beverage, again with the rate of ascention being depending on the difference in density between the particle and the beverage in which it is immersed.

In specific embodiments, the beverage bits are formulated to have a density or a range of densities, that is different, whether higher or lower, than a particular target beverage. The difference in density between the beverage bits and the target beverage can be in the range of 0.001 g/mL to 0.5 g/mL. For example, a density difference between the beverage bits and the target beverage can be 0.001 to 0.01 g/mL, or from 0.002 to 0.009 g/mL, or from 0.003 to 0.008 g/mL, or from 0.004 to 0.007 g/mL, or from 0.005 to 0.006 g/mL, or from 0.01 to 0.02 g/mL, or from 0.025 to 0.03 g/mL, or from 0.035 to 0.04 g/mL, or from 0.045 to 0.05 g/mL, or from 0.06 to 0.07 g/mL, or from 0.08 to 0.09 g/mL, or from 0.1 to 0.15 g/mL, or from 0.2 to 0.3 g/mL, or from 0.35 to 0.4 g/mL, or from 0.45 to 0.5 g/mL, or from 0.55 to 0.6 g/mL, or from 0.65 to 0.7 g/mL, or from 0.75 to 0.8 g/mL, or from 0.85 to 0.9 g/mL. Density differences between the beverage bits and a target beverage can also be calculated based on percentage. Beverage bits, for example, can be formulated to have a difference in density that is up to 10% that that of the target beverage. Beverage bits that are 10% more dense than the beverage in which it is introduced will fall to the bottom, while beverage bits that are 10% less dense will float to the top. Beverage bits can be formulated to be 0-9% more or less dense than the target beverage, such as about 1-8% different, or 2-7% different, or 3-6% different, or 4-5% different.

As illustrated in FIGS. 1 and 2 more specifically, beverage bits 10 are added to beverage 40 just before consumption. This could be lime to a Corona™ Beer; strawberry to a bottle of Dasani™ Strawberry Water; lemon to BACARDI SILVER™; grapes to a SoBe™ Fruit Punch; and the list goes on. In a preferred embodiment, the consumer takes the cellophane wrapper 20 and tears it open to gain access to the beverage bits 10. In another embodiment, shown in FIG. 2, the consumer turns cap 30 upside and uses the tip end of their finger to pop open, or tear, plastic film (not shown) exposing beverages bits 10 contained inside. In both embodiments the beverage bits 10 are then deposited into the beverage 40. Beverage bits 10 do not sink to the bottom of bottle 50; do not float on the top; and bottle 50 does not have to be shaken to distribute them.

Because beverage bits 10 have differing levels of water content they are suspended at different levels in beverage 40 when poured in. When initially added to the beverage, the beverage bits 10 do not sink to the bottom of bottle 50; do not float on the top; and bottle 50 does not have to be shaken to distribute them. Based on their density, beverage bits 10 are suspended in the beverage 40 at various height levels, with the less dense beverage bits 10 rising toward the top, and the heavier, denser ones, falling nearer the bottom.

Beverage bits 10 remain suspended heterogeneously so that the consumer gets a sudden burst of flavor intermittently with every mouthful. This completely solves the problem of neural adaptation and beverage 40 simply tastes better. The consumer gets a few pieces of beverage bits 10 with each mouthful from their very first one to the last one. From a health standpoint, adding beverage bits 10 could be an excellent source of nutrients supplying desirable antioxidants and other beneficial phytochemicals because dried fruits retain most of the nutritional value of fresh fruits. This now means that all beverages, including soft drinks, could be healthier to drink. The consumer can even have a choice of different flavors, so that lemon might be added to their strawberry water, or strawberry to their lemon water.

In another embodiment, the beverage bits 10 can have differing amounts of edible material coated on the exterior of the fruit bit, which allows the fruit particles to be suspended in a beverage at different levels in beverage 40 when poured in. The fruit bits are first processed as described above and preferably dehydrated at least to some extent. The entire disclosure above pertaining to processing and preparing the fruit bits with varied densities applies to preparing the fruit bits with an additional coating material. Based on the amount of coating of edible material on the exterior, beverage bits 10 are suspended throughout beverage 40 at various height levels, with beverage bits 10 having less coating rising toward the top, and the heavier, more coated ones, falling nearer the bottom. The fruit pieces are coated with different amounts of edible material in order to vary the weight of each piece. Beverage bits with no coating may float on the top of the beverage. Beverage bits 10 remain suspended heterogeneously because the coating is evenly varied so that the consumer gets a sudden burst of flavor intermittently with every mouthful.

The natural or semi-natural fruit bits are typically 1/16 inch cubes that have edible material coating the exterior of each piece in various amounts. The amount of edible coating added to the bits is selected based on the beverage it will be added to. For example, for beverages with a high density or higher viscosity, beverage bits with more added edible material will suspend better in the beverage, while beverages that are less dense or have a lower viscosity may need beverage bits formulated with less coating. Some of the bits will have no coating, or very limited coating, in order to float on the surface of the beverage or rise to a level within the beverage that is nearer the surface than the bottom. In embodiments, the small pieces of fruit, i.e., beverage bits, are provided to the consumer in one or more packets, such as cellophane or foil, or a package containing multiple packets or compartments to segregate the fruit bits according to a desired need. The packets can contain a range of beverage bits having various particle sizes, densities, flavors, or amounts of coating material. Alternatively, the beverage bits can be provided by grouping the particles by like characteristics, such as providing a package of coated beverage bits having about the same amount of coating. The beverage bits may be packaged in any material capable or maintaining freshness of real or artificial fruit and are not limited to cellophane wrappers. Once removed from the packaging, the bits are added by the consumer to the beverage where the fruit pieces suspend at various depths within the beverage. Fruit pieces with little to no coating may be disposed in the upper portion, while fruit pieces with more coating may suspend at lower levels. In some embodiments, and depending on the beverage in which the beverage bits are added, some of the fruit particles may float at the top of the beverage or sink to the bottom, especially over time as the edible coating may dissolve. As the consumer drinks the beverage, the fruit bits swallowed by the consumer will enhance the flavor of each sip.

The edible material added to the bits can comprise any material capable of adding weight to the bits and that can be ingested. The edible material can comprise sugar, or any sugar mixture, gelatin, fruit matter, or combinations thereof. In formulating fruit bits for particular applications, typically beverages with a high density will require bits with more added edible material over those that are less dense. Sweeteners usable in fruit bits of the invention, whether incorporated into the fruit material, the added edible material, or both, can include artificial or non-nutritive sweeteners such as saccharin, saccharin sodium, aspartame, acesulfame-K, sucralose and neotame; and sugar alcohols such as sorbitol, erythritol and xylitol; stevia can also be used. The sweetener, or mixture of sweeteners, can be present in the compositions in an amount ranging from about 0.1 wt % to about 99.9 wt % based on the total weight of the composition. Preferred embodiments of compositions of the invention comprise non-nutritive sweetener in an amount ranging from about 0.5 to 2% based on weight. Other embodiments can comprise about 1-5%, or from about 6-10%, or from about 11-20%, or from about 21-30%, or from about 31-40%, or from about 41-50%, or from about 51-60%, such as from about 61-70%, or 71-80%, or 81-90%, or 91-95%, or 96-98%, and so on.

Other embodiments include real, artificial, or partially artificial fruit bits with added edible material where the material is injected into the bits, instead of as an exterior coating. The edible material that is injected into the fruit bits can be in any form, such as a liquid, semi-solid, or gel. The fruit bits can have a center filling, whether or not actually injected into the fruit bit. For example, the center filling can be provided and fruit material is pressed or formed around the center filling. In such embodiments, the interior of the fruit bit can have a jam-like consistency, which is jelled in part by the action of pectin in the presence of food grade acid. Additives, such as minerals and vitamins can be injected into or added to the fruit bits to add weight. Likewise, sugar, sugar mixtures, or any substance capable of being ingested, can be injected into each bit at various amounts or quantities thereby giving the bits differing weights. Similarly, air can be injected into the fruit bit to provide lift to the fruit particle when added to the beverage. Similar to the embodiment described above with the fruit bits comprising an edible coating, the bits with more added edible material will have a greater weight which will cause the pieces to sink lower than those with less added material. With the beverage bits disposed throughout the beverage, the consumer has the ability to enjoy the beverage bits from the first sip to the last.

Viscosity of the beverages may also be a factor in whether the fruit particles, the coated fruit particles, or the fruit particles injected with edible material will suspend in a particular beverage. Embodiments of the invention include fruit particles capable of suspending in beverages with a viscosity ranging from 0-1000 centipoise (cP). For example, the beverages can have a viscosity ranging from about 0-20 cP, or from about 20-40 cP, or 40-60 cP, or from about 60-80 cP, 80-100 cP, 100-120 cP, 120-140 cP, 140-160 cP, 160-180 cP, or from about 180-200 cP, 200-225 cP, 225-250 cP, 250-275 cP, 275-300 cP, 300-325 cP, 325-350 cP, 350-375 cP, 375-400 cP, 400-425 cP, 425-450 cP, 450-475 cP, 475-500 cP and 500-1000 cP, with preferred embodiments ranging from 10-150 cP. See Flux-Gerate GMBH, FLUX High Viscosity Liquid Pumps, F500 097/4 EFA, page 21, no date provided.

Additional embodiments include fruit bits that have been dehydrated, then an edible material injected into the fruit bit and the fruit bit coated with an edible material. The fruit particles can be any size ranging from smaller than 1/64 inch to 2 inches and can have any geometric or abstract shape. For example, ⅛ inch spherical or round fruit bits can be prepared and can further comprise added edible material that is both added to the exterior and injected into the beverage bit. The amount of edible material on the exterior can be greater than, less than, or equal to the amount of edible material added to the interior of a beverage bit. Additionally, the composition of the edible material on the exterior can be identical or vary from the edible material added to the interior. The total amount of edible material added to a fruit bit, whether injected or coated on the fruit bit, can be formulated depending on the target beverage to which it is expected to be added. The injected and coated beverage bits when added to a beverage will be disposed at various levels within the beverage depending on the respective weights of the fruit particles. For two fruit bits of the same size and density, if one has a weighted coating of a selected amount and the other has a weighted coating of an equivalent amount but also added material injected into the fruit bit, then the second fruit bit will weigh more and tend to be disposed lower than the first fruit bit within the beverage.

The edible material coating, or material injected into, or otherwise added to the beverage bit can comprise any sugar based, starch based, or any edible organic or inorganic substance intended for human consumption, or any combination thereof. Indeed, any food additive generally regarded as safe (GRAS) can be used. Many commercially available edible coatings utilize a synthetic cellulosic polymer such as hydroxypropyl-methylcellulose (HPMC). Other synthetic film-formers which are commonly used include ethylcellulose, methylcellulose, polyvinylpyrrolidone, and polydextrose. These coating materials may be used alone or in combination with secondary film-formers such as sodium alginate or propylene glycol alginate. The foregoing are usually used in combination with other ingredients including fillers, for example, lactose or maltodextrin; plasticizers, such as polyethylene glycols, dibutyl sebacate, and triethyl citrate; surfactants; and often coloring materials such as a food dye or pigment, including opacifiers such as titanium dioxide and the like, or combinations thereof, such as is described in U.S. Pat. No. 6,432,448, entitled “Edible Coating Composition.”

Coating compositions can comprise any water-soluble or water-insoluble material depending on the desired properties of the coating. For example, for coated fruit bits with a water-soluble coating, if dispersed in a water-based beverage, the coating will begin to dissolve in the beverage when added thereto. As the coating dissolves, the fruit bit will ascend to a different level in the beverage until the entire coating has dissolved and the fruit bit floats on the top surface of the beverage. If water-insoluble coatings are used, such as wax, fat or oil, the fruit bits will suspend at different levels within the beverage and remain suspended. The fruit bits can be formulated to suspend for a duration of time that is over the course of drinking the beverage if added by the consumer, or can be formulated to suspend indefinitely in the beverage if added during the manufacturing process and provided already in the beverage at the point of sale. The fruit bits can comprise one or more layers of the same or different coatings. Preferably, fruit bits are formulated using one or more of the processes or process steps described in U.S. Patent Application Publication No. 2009/0202683, entitled “Confections with Chewy, Sour and Creamy Attributes, and Methods to Make and Use the Same.”

The edible material can also be comprised of low molecular weight solutes such as sugars, more specifically, sucrose, or of humectants such as glycerol such as is described in U.S. Pat. No. 5,718,931, entitled “Fabricated Fruit Pieces and Method of Preparation.” Additionally, the edible coating can comprise substances (filmogenic substances) including derivatives of cellulose, modified starch, dextrins, gelatine, zeins and their mixtures. The cellulose derivatives mentioned include such water-soluble derivatives as ethyl cellulose, hydroxypropylmethyl cellulose, carboxymethyl cellulose, methyl cellulose, sodium hydroxymethyl cellulose and their mixtures as described in U.S. Published Patent Application Publication No. 2005/0214414, entitled “Edible film-coated dried fruit and production method thereof.” Even further, substances such as ethyl cellulose, hydroxypropyl cellulose, hydroxypropyl methyl cellulose, cellulose phthalate acetate, ethyl cellulose, polyvinyl pyrrolidine, sodium ethyl cellulose sulphate, zein or polyvinyl phthalate acetate can also be used. Edible material can also include any fruit or vegetable juice, any gel or gelatin, or combination of substances previously described. Edible material can also be formed of shellac. Moreover, the edible material can be added during processing or after and can include methods such as, but not limited to, subjecting the fruit bits to injecting, spraying, and immersing to achieve the desired amount of added weighting material.

Additional embodiments according to the invention can include 1/16 inch spherical or round fruit bits with 100% natural fruit. The fruit bits can comprise varying levels of added edible material comprising sucrose that is sprayed onto the exterior of the beverage bits. The sucrose or any other edible substance can also be applied by immersing the bit or injecting it. If by immersion, the fruit bits can be immersed in a liquid solution, then removed to allow the coating to form on the exterior surface of the fruit bit, then immersed in the solution repeatedly and dried until the desired amount of coating is deposited on the fruit bit. In particular embodiments, for example, the fruit bits can be formulated to have coatings, injected material, or material otherwise added to the fruit bit, where the additional material increases the weight of the fruit bit by about 0.25 mg to about 10 mg. Preferred coatings or added material add a weight of about 0.5 mg to about 5 mg, such as about 0.75 mg to about 3 mg, such as for example about 1-2 mg to the fruit bit.

Additional embodiments of the invention include ⅛ inch cube fruit bits with 100% natural fruit. The bits comprise varying levels of added edible material injected into the beverage bits. The edible substance can also be applied by immersing the bit or spraying it onto the exterior. The total amount of edible material added to a bit can be formulated for a beverage with a particular density. For example, for a target beverage having a density of about 1.10 g/mL, the dehydrated fruit bits, prior to adding a coating or injected material, can also have a density of about 1.10 g/mL. The fruit bits can then be coated, injected, or otherwise processed to include additional edible material to increase the weight of one or more of the fruit bits. For example, some of the fruit bits can comprise 5 mg of material injected into the fruit bit, while other of the beverage bits can have a coating of about 1-2 mg of added material. Further, some of the fruit bits can be injected with 3-4 mg of edible material and then coated with an addition 3-4 mg of edible material. This will result in a collection of beverage bits having different weights. Such a grouping of bits can be packaged in a single wrapper for the consumer, or can be separated by weight and packaged for the consumer. The consumer then removes the beverage bits from the packaging and adds them to a beverage for consumption. Once added, the bits then disperse in the beverage to different levels to impart a confetti-like appearance.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. Where a range of values is provided in this specification, each value between the upper and lower limits of that range is also specifically disclosed. The upper and lower limits of these smaller ranges may independently be included or excluded in the range as well. As used in this specification, the singular forms “a,” “an,” and “the” include plural referents unless the context clearly dictates otherwise. It is intended that the specification and examples be considered as exemplary in nature and that variations that do not depart from the essence of the invention are intended to be within the scope of the invention. Further, the references cited in this disclosure are incorporated by reference herein in their entireties.

1. A composition comprising:
a plurality of particles comprising fruit material, each coated or injected with an edible material to provide a group of coated or injected fruit bits;
wherein two or more of the coated or injected fruit bits have a buoyancy in a target beverage and the edible material provides weight for counteracting the buoyancy and suspending the two coated or injected fruit bits at different levels when dispersed in a target beverage.

2. The composition of claim 1, wherein the edible coating is a water-insoluble coating comprising wax.

3. The composition of claim 1, further comprising added vitamins and minerals.

4. The composition of claim 1, wherein the fruit material comprises a moisture content ranging from 0% to about 90% based on weight.

5. The composition of claim 1, wherein the coated or injected fruit bits having one or more of a length, width, height, or diameter of about 1/128th to ¼th inch.

6. The composition of claim 1, wherein the fruit material is processed by one or more of blending, pureeing, heating, or dehydrating.

7. The composition of claim 1, wherein the coated or injected fruit bits are packaged by segregating the coated or injected fruit bits by one or more of weight, density, volume, or particle size.

8. The composition of claim 1, wherein the coated or injected fruit bits comprise air to add buoyancy to the coated or injected fruit bits when dispersed in a beverage.

9. The composition of claim 1, wherein the coated or injected fruit bits are formulated to suspend in a target beverage having a density ranging from 0.8 g/ml to 1.3 g/ml.

10. The composition of claim 1, wherein the coated or injected fruit bits are formulated to suspend in a target beverage having a viscosity ranging from about 10 cP to about 110 cP.

11. The composition of claim 7, wherein the package is a cellophane wrapper or a beverage cap with a foil or plastic seal for retaining the coated or injected fruit bits within the cap.

12. The composition of claim 11, wherein the cellophane wrapper or cap has multiple compartments for segregating the coated or injected fruit bits by one or more of weight, density, volume, or particle size.

13. A method for reducing neural adaptation from drinking comprising:
suspending a plurality of particles comprising fruit material, each coated or injected with an edible material to provide a group of suspended coated or injected fruit bits;
wherein two or more of the suspended coated or injected fruit bits have a buoyancy in a target beverage and the edible material provides weight for counteracting the buoyancy and suspending the two coated or injected fruit bits at different levels when dispersed in the target beverage;
wherein neural adaptation is reduced when the suspended coated or injected fruit bits are consumed while drinking the beverage.

14. A composition comprising a plurality of particles comprising fruit material, wherein two or more of the plurality of particles differ in weight based on differing weights of coated or injected material.

15. The composition of claim 1, wherein the plurality of particles comprise fruit material injected with an edible material.

16. The composition of claim 1, wherein two or more of the fruit bits remain suspended for up to about 2 hours.

17. The composition of claim 1, wherein the edible material adds a weight of 0.5 to 5 mg to each fruit bit.

18. The composition of claim 1, wherein the edible material adds a weight of 0.75 to 3 mg to each fruit bit.

19. The composition of claim 1, wherein the edible material adds a weight of 1-2 mg to each fruit bit.

20. The composition of claim 1, wherein the edible material comprises sugar.
